(19) United States
(12) Patent Application Publication
(10) Pub. No.: US 2011/0049189 A1
(43) Pub. Date: Mar. 3, 2011

(54) Extrusion tool

(75) Inventors: Rainer Strobel-Schmidt, Bad Woerishofen (DE); Christian Hefele, Breitenbrunn (DE); Peter Ostermeier, Diessen (DE); Hans Peter Lederle, Durach (DE)

(73) Assignee: Hilti Aktiengesellschaft, Schaan (LI)

(21) Appl. No.: 12/806,979

(22) Filed: Aug. 25, 2010

(30) Foreign Application Priority Data
Sep. 3, 2009 (DE) DE 102009039844.9

(51) Int. Cl. B67D 7/84; B65D 35/22; B67D 7/70; B65D 88/54

(52) U.S. Cl. 222/165; 222/326; 222/327; 222/94; 222/137

(57) ABSTRACT

An extrusion tool (11) for compound-containing containers, including an extrusion device (12) and a cartridge (32) for the container. The extrusion device (12) includes an extrusion mechanism (13) and a holding receptacle (23) for the cartridge (32). The holding receptacle (23) is bounded at the front end by an end plate (24) and at the rear end by a housing wall (20) of the extrusion mechanism (13). The cartridge (32) is attached to the extrusion device (12) such that it is pivotable about a pivot axis (27) extending from the end plate (24) to the housing wall (20), and is movable from an extrusion position to a loading position. And an extrusion device (12) for such an extrusion tool (11), and to a cartridge (32) for such an extrusion tool (11).

This claims the benefit of German Patent Application DE 10 2009 039 844.9, filed Sep. 3, 2009 and hereby incorporated by reference herein.

The present invention relates to an extrusion tool for compound-containing containers. The present invention further relates to an extrusion device for such an extrusion tool and to a cartridge for such an extrusion tool.

### BACKGROUND

Such an extrusion tool is used for dispensing compounds which are packaged in containers, such as mortar and sealing compounds, at a site of application. The containers may, for example, include foil bags which are filled with one or more components of the compound to be dispensed and which are inserted in a separate cartridge or in a cartridge attached to the extrusion device.

U.S. Pat. No. 2,788,159 describes an extrusion tool for compound-containing containers, including an extrusion device and a cartridge for the container. The extrusion device includes an extrusion mechanism and a holding receptacle for the cartridge, the holding receptacle being bounded at the front end by an end plate and at the rear end by a housing wall of the extrusion mechanism. The cartridge includes a receiving body for insertion of a container or direct placement of the material thereinto. The cartridge is inserted into the holding receptacle of the extrusion device and the compound is extruded therefrom in response to actuation of the extrusion mechanism, the extrusion mechanism including, for example, a piston rod and a thrust member.

The drawback of the known approach is that in order to ensure a smooth extrusion process, the separate cartridge must be precisely positioned within the holding receptacle of the extrusion device, which requires multiple manual operations to be performed by the user.

U.S. Pat. No. 6,082,597 describes an extrusion tool of the above-mentioned type for use with compound-containing containers, including an extrusion device and a cartridge for the container. The extrusion device includes an extrusion mechanism and a holding receptacle for the cartridge. The cartridge is attached to the extrusion device such that it is pivotable about a pivot axis extending perpendicular to the extrusion direction, and is movable from an extrusion position to a loading position.

The drawback of the known approach is that the forces occurring during the extrusion of the compound must be taken up by the attachment points for the cartridge on the extrusion device, which define the pivot axis. In order to ensure the usability of the extrusion tool, the attachment points must be of a sufficiently massive construction.

### SUMMARY OF THE INVENTION

It is an object of the present invention to provide an extrusion tool for compound-containing containers that will overcome the aforementioned disadvantages and is easy to handle. Another alternate or additional object of the present invention is to provide an extrusion device for such an extrusion tool as well as a cartridge for such an extrusion tool.

In the extrusion tool according to the present invention, the holding receptacle is bounded at the front end by an end plate and at the rear end by a housing wall of the extrusion mechanism, the pivot axis extending from the end plate to the housing wall.

Thus, the pivot axis extends parallel to the longitudinal extent of the holding receptacle and parallel to the extrusion direction of the extrusion device. Advantageously, the pivot axis extends along a side wall or lateral boundary (e.g., a connecting rod) of the holding receptacle which laterally bounds the holding receptacle. The cartridge is at least partially connected to the extrusion device such that it is pivotable with respect thereto, which allows for easy loading by swinging the cartridge into and out of the holding receptacle of the extrusion device. Since the cartridge is connected to the extrusion device, it cannot fall off accidentally during operation or during manipulation of the extrusion tool.

When secured in position on the extrusion device, the cartridge has only one degree of freedom in which it is swingable or rotatable. Thus, when the cartridge is in the swung-in position, in which it is located in the extrusion position in the holding receptacle of the extrusion device, it is located in a defined position, which significantly reduces the effort required to load the extrusion tool.

A particular feature of the extrusion device is that it is easy to handle. One hand holds the extrusion tool with the cartridge while the other hand holds the container. Advantageously, the hand initially holding the container is then used to swing the cartridge into the extrusion position or into the loading position, respectively.

Due to this configuration of the extrusion tool, the bearing arrangement of the cartridge is not exposed to the forces occurring during extrusion, or only to a small fraction of said forces. This allows for a simple and inexpensive design for the bearing of the cartridge on the extrusion device.

Preferably, the cartridge is releasably attached to the extrusion device, so that it can be completely removed from the extrusion device as needed. Opened containers that are not yet completely empty may be removed from the extrusion device along with the cartridge and replaced with another cartridge holding a new container. An opened container may be stored until later use in the cartridge that has been removed from the extrusion device.

Advantageously, the bearing arrangement of a cartridge which is releasably attachable to the extrusion device is designed such that the cartridge can be removed from the extrusion device only when in a certain angular position. This substantially prevents the cartridge from unintentionally detaching from the extrusion device, for example during swinging movement thereof.

Multi-component compounds are packaged in one container in different mixing ratios of components, depending on the requirements to be met by the dispensed compound. Extrusion of the multi-component compounds is accomplished using, for example, a cartridge having a receiving body containing a plurality of parallel receiving chambers. Depending on the geometric configuration of the container, the corresponding cartridge may be secured in position on the extrusion device. The device of the present invention allows compounds to be easily dispensed in different mixing ratios of components.

Preferably, a locking device is provided for locking the cartridge in the extrusion position and/or the loading position. This allows the cartridge to be temporarily held in position for ease of handling. Advantageously, the locking device includes a latch means provided on the cartridge and/or on the extrusion device and a mating latch means provided on the extrusion device and/or on the cartridge. This allows the cartridge to be securely held in its respective positions in a simple manner. Also, advantageously, a locking element is provided on the cartridge and/or on the extrusion device which, when actuated, allows the cartridge to be moved, for example, from a locked position to a rotatable position

The inventive extrusion device for an extrusion tool includes an extrusion mechanism, a holding receptacle for a cartridge, and attachment means for the cartridge. The holding receptacle is bounded at the front end by an end plate and at the rear end by a housing wall of the extrusion mechanism. The cartridge is attachable to the extrusion device such that it is pivotable about a pivot axis which is defined by the attachment means and about which the cartridge is movable from an extrusion position to a loading position. The attachment means include a first bearing point in the region of the end plate and a second bearing point in the region of the housing wall of the extrusion device.

The extrusion device is simple in configuration and provides flexibility with respect to the cartridge to be received.

The extrusion mechanism of the extrusion device includes an extrusion means, e.g., a thrust member which acts directly on the container containing the compound to be extruded, or on an extrusion piston provided in the receiving body of the cartridge. The extrusion mechanism may be actuated mechanically, electrically, or by a suitable fluid, such as water, oil, or air. Further, for example, at least one piston rod is provided, which can be moved by the extrusion mechanism relative to the holding receptacle of the extrusion device so as to extrude the compound.

Preferably, the first bearing point and/or the second bearing point is/are provided by a spherical element which, after attachment of the cartridge, allows the cartridge to swing in all directions. Preferably, the spherical element takes the form of a pin having a spherical portion.

Preferably, the second bearing point and/or the first bearing point is/are provided by a concave receptacle which serves to receive a cylindrical element and which, after attachment of the cartridge, allows swinging movement in one direction only. Advantageously, the concave receptacle has resilient sections which snap over the cylindrical element during the attachment process. This allows the cartridge to be easily attached to and removed from the extrusion device.

Particularly advantageously, the first bearing point or the second bearing point is provided by a spherical element and the other bearing point is provided by a concave receptacle, which allows for easy attachment of a cartridge which is releasably attachable to the extrusion device. The cartridge is first positionally secured to the spherical element and then suitably swung into the position in which the cartridge can be positionally secured to the concave receptacle.

The inventive cartridge for an extrusion tool has at least one receiving body for the container containing the compound to be extruded, said receiving body having a first end and a second end spaced therefrom. The receiving body is provided with a first bearing point in the region of the first end and a second bearing point in the region of the second end.

The cartridge is simple in configuration and provides flexibility with respect to its use.

Preferably, the first bearing point and/or the second bearing point is/are provided by a spherical cap-shaped receptacle for receiving a spherical element. This allows the cartridge to be swung in all directions about the spherical element when in a partially attached position. When brought together, the spherical cap-shaped receptacle and the spherical element together form a ball-and-socket joint.

Preferably, the second bearing point and/or the first bearing point is/are provided by a cylindrical element to be received in a concave receptacle, so that the cartridge can be swung in only one direction about the cylindrical element when in a partially attached position. Preferably, the cylindrical element takes the form of a pin having at least one cylindrical portion.

Particularly advantageously, the first bearing point of the cartridge or the second bearing point of the cartridge is provided by a spherical cap-shaped receptacle and the other bearing point is provided by a concave receptacle, which allows for easy attachment of the releasable cartridge to the extrusion device. The cartridge is first positionally secured to the spherical element of the extrusion device and then suitably swung into the position in which the cartridge can be positionally secured to the cylindrical element.

Preferably, a locking element is provided on the cartridge to fix the cartridge in the extrusion position and/or loading position on the extrusion device, which allows for easy positioning and/or loading of the at least partially attached cartridge. When the cartridge is in the extrusion position, in which it is swung into the holding receptacle of the extrusion device, the locking element advantageously prevents undesired displacement of the cartridge within and from the holding receptacle, which could hinder the extrusion operation.

### BRIEF DESCRIPTION OF THE DRAWINGS

The present invention is explained in greater detail below with reference to an exemplary embodiment. In the drawing,

FIG. 1 is a view of an extrusion tool, shown with the cartridge in a swung-out position;

FIG. 2 is a front elevation view of the extrusion tool of FIG. 1, looking at the end plate;

FIG. 3 is a side view of an extrusion device;

FIG. 4 is a perspective view of a cartridge; and

FIG. 5 is a plan view of a container for the compound to be extruded.

### DETAILED DESCRIPTION

In the drawings, like reference numerals are used to indicate like parts throughout the various views.

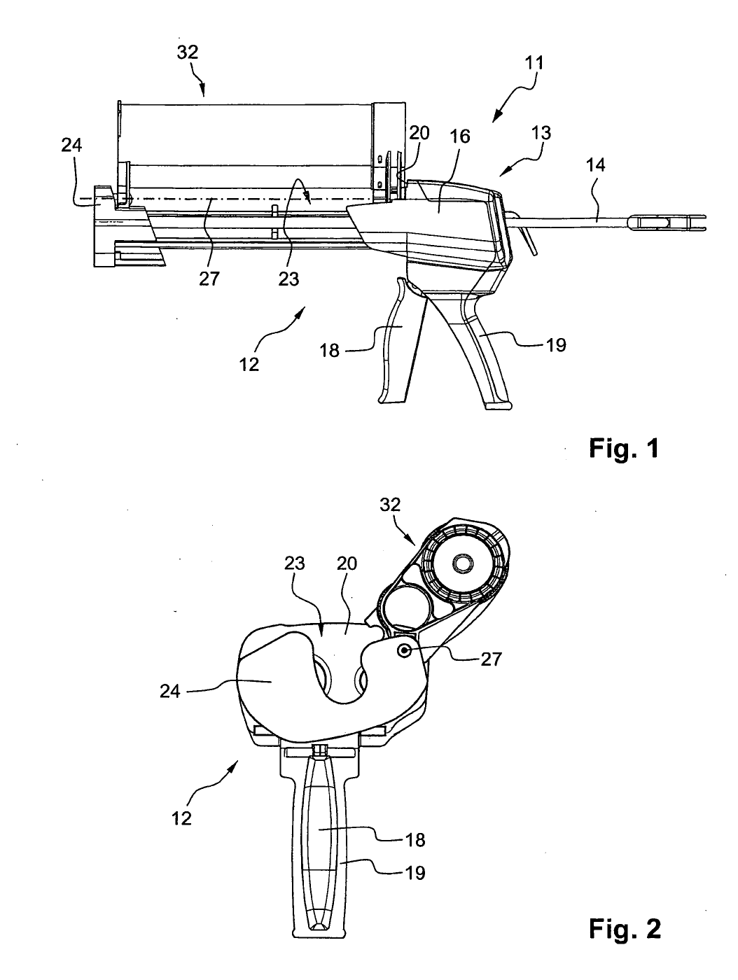

Extrusion tool 11 for compound-containing containers 46, as shown in FIGS. 1 and 2, includes an extrusion device 12 and a cartridge 32 for container 46, said cartridge being releasably attached to extrusion device 12.

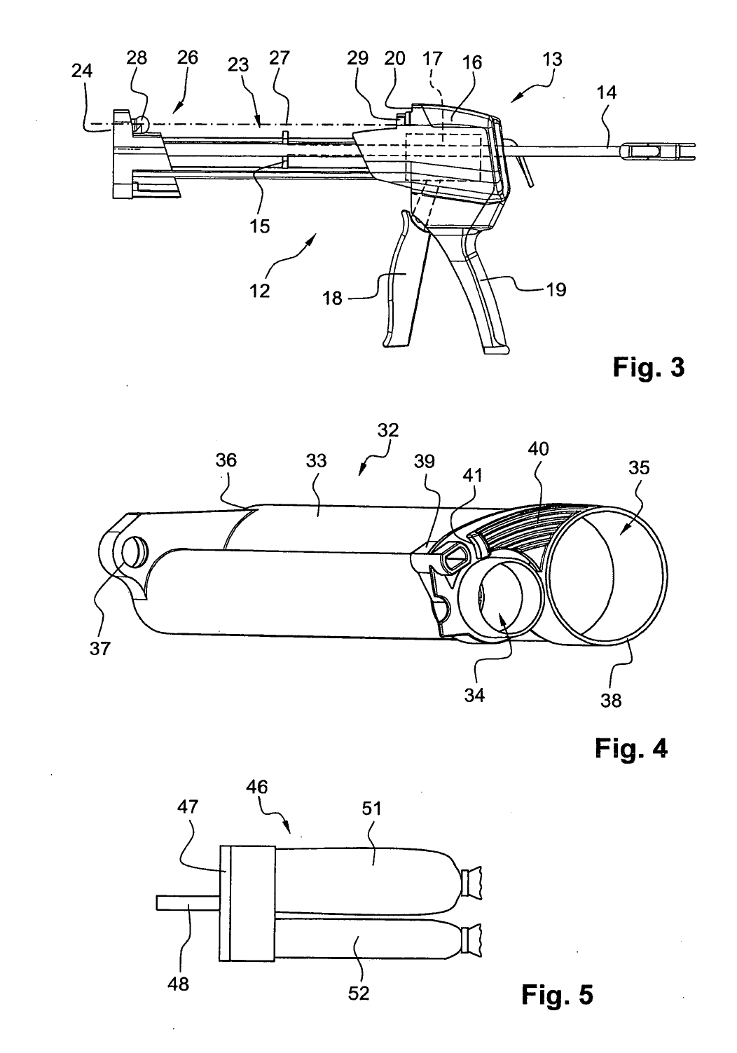

In this example, extrusion device 12, shown separately in FIG. 3, includes a mechanically actuatable extrusion mechanism 13 and a holding receptacle 23 for cartridge 32. Extrusion mechanism 13 includes two piston rods 14, only one of which can be seen in the side view and which are each provided with a thrust member 15 at the end facing holding receptacle 23. An advancing mechanism 17, shown here only schematically, is disposed in housing 16 and includes, for example, clamping members as advancing elements which can be brought into contacting engagement with piston rods 14, said advancing mechanism being actuatable by a trigger 18 which is pivotable relative to handle 19 so as to advance piston rods 14 accordingly.

Holding receptacle 23 for cartridge 32 is bounded at the front end by an end plate 24 and at the rear end by a housing wall 20 of extrusion mechanism 13. Further, extrusion device 12 is provided with attachment means 26 for cartridge 32, said attachment means defining a pivot axis 27. Cartridge 32 is attachable to extrusion device 12 such that it is pivotable about said pivot axis and movable from an extrusion position to a loading position. Pivot axis 27 extends parallel to the longitudinal extent of piston rods 14, which define the extrusion direction of extrusion tool 11, i.e., from end plate 24 to housing wall 20 of housing 16 of extrusion mechanism 13. Attachment means 26 include a first bearing point 28 in the region of end plate 24 and a second bearing point 29 in the region of housing wall 20. First bearing point 28 of attachment means 26 includes a spherical element projecting from end plate 24 in a direction toward housing wall 20. Second bearing point 29 of attachment means 26 includes a concave receptacle which projects from housing wall 20 in a direction toward end plate 24 and which, in the view of FIG. 3, is upwardly open.

Cartridge 32, which is shown separately in FIG. 4, is formed by a receiving body 33 containing two parallel receiving chambers 34 and 35 for a container 46 and having a first end 36 and a second end 38 spaced therefrom. Receiving body 33 of cartridge 32 is provided with a first bearing point 37 in the region of first end 36, said first bearing point being configured as a spherical cup-shaped receptacle for receiving the spherical element of first bearing point 28 of extrusion device 12. Receiving body 33 of cartridge 32 is provided with a second bearing point 39 in the region of second end 38, said second bearing point being configured as a cylindrical element to be received in the concave receptacle of first bearing point 29 of extrusion device 12.

In an alternative embodiment, one of the bearing points 37 or 39 of cartridge 32 has a spherical element, and the corresponding bearing point 28 or 29 of extrusion device 12 has a spherical cup-shaped receptacle for receiving this spherical element. Also, in a variant embodiment, one of the bearing points 37 or 39 of cartridge 32 may be configured as a concave receptacle for receiving a cylindrical element of the corresponding bearing point 28 or 29 of extrusion device 12. In a further, but not final, alternative embodiment, bearing points 28 and 29 of extrusion device 12, or bearing points 37 and 39 of cartridge 32, are configured as cylindrical elements, and the elements cooperating therewith when extrusion tool 11 is in the assembled state are configured as concave receptacles.

Cartridge 32 is provided with a locking element 40 which is pivotable to a limited extent and forms part of a locking device for locking cartridge 32 to extrusion device 12 in the extrusion position and the loading position. Locking element 40 includes a locking portion 41 which, when cartridge 32 is in the swung-in, fixed position, cooperates with or engages behind a portion of second bearing point 29, for example. Alternatively, a separate pin may be provided which may, for example, projects from housing wall 20 of housing 16 and which provides an interlocking point for locking element 40; i.e., for locking portion 41. Advantageously, locking element 40 locks in one direction and is able to flex in a different direction to allow for easy release.

FIG. 5 shows a container 46, the contents of which can be extruded using the extrusion device. Container 46 has a head portion 47 containing an outlet nozzle 48, which may have provided therein a static mixer as a device for mixing the compound. Attached to head portion 47 are a first foil bag 51 containing a first component of a multi-component compound and a second foil bag 52 containing a second component of the multi-component compound.

In order to extrude the multi-component compound, cartridge 32, which is releasably attached to the extrusion device, is swung into its loading position (see FIGS. 1 and 2), and container 46 is inserted into receiving body 33 of cartridge 32 from its first end 36. Upon application of pressure to the locking element 40 of cartridge 32, the cartridge can be swung about pivot axis 27 of attachment means 26 of extrusion device 12 and into its holding receptacle 23. Once cartridge 32 is swung entirely into holding receptacle 23 of extrusion device 12, and is thus in the extrusion position, locking element 40 locks cartridge 32 in this position. The multi-component compound can be dispensed using extrusion tool 11 by actuation of trigger 18.

Alternatively, first, container 46 is inserted into cartridge 32 and then cartridge 32 is attached to extrusion device 12.

What is claimed is:

1. An extrusion tool for compound-containing containers, comprising:
an extrusion device; and
a cartridge for the container,
the extrusion device including an extrusion mechanism and a holding receptacle for the cartridge, the cartridge being pivotally attached to the extrusion device about a pivot axis to be movable from an extrusion position to a loading position, the extrusion mechanism having a housing wall and the holding receptacle having a front end and a rear end,
the holding receptacle being bounded at the front end by an end plate and at the rear end by the housing wall of the extrusion mechanism, the pivot axis extending from the end plate to the housing wall.

2. The extrusion tool as recited in claim 1 wherein the cartridge is releasably attached to the extrusion device.

3. The extrusion tool as recited in claim 1 further comprising a locking device for locking the cartridge in the extrusion position and/or the loading position.

4. An extrusion device for an extrusion tool as recited in claim 1, comprising:
an extrusion mechanism;
a holding receptacle for a cartridge; and
attachment means for the cartridge, the attachment means defining a pivot axis, and the cartridge being attachable to the extrusion device such that the cartridge is pivotable about said pivot axis and movable from an extrusion position to a loading position,
the holding receptacle being bounded at the front end by an end plate and at the rear end by a housing wall of the extrusion mechanism; and
the attachment means including a first bearing point in a region of the end plate and a second bearing point in a region of the housing wall.

5. The extrusion device as recited in claim 4 wherein the first bearing point and/or the second bearing point is/are provided by a spherical element.

6. The extrusion device as recited in claim 4 wherein the second bearing point and/or the first bearing point is/are provided by a concave receptacle.

7. A cartridge for an extrusion tool as recited in claim 1, comprising:
at least one receiving body for the container containing the compound to be extruded, the receiving body having a first end and a second end spaced therefrom, the receiving body having a first bearing point in a region of the first end and a second bearing point in a region of the second end.

8. The cartridge as recited in claim 7 wherein the first bearing point and/or the second bearing point is/are provided by a spherical cap-shaped receptacle for receiving a spherical element.

9. The cartridge as recited in claim 7 wherein the second bearing point and/or the first bearing point is/are provided by a cylindrical element to be received in a concave receptacle.

10. The cartridge as recited in claim 7 further comprising a locking element provided on the cartridge to fix the cartridge in the extrusion position and/or loading position on the extrusion device.
